(19) United States
(12) Patent Application Publication
(10) Pub. No.: US 2007/0111891 A1
(43) Pub. Date: May 17, 2007

(54) Process for producing artificial flower with natural plant and finishing agent for use therein

(75) Inventor: Kyoko Inao, Kyoto (JP)

Correspondence Address: KIRSCHSTEIN, OTTINGER, ISRAEL;& SCHIFFMILLER, P.C., 489 FIFTH AVENUE, NEW YORK, NY, 10017, US

(73) Assignee: KYOKA CRAFT, INC., Kyoto (JP)

(21) Appl. No.: 10/564,695

(22) PCT Filed: Jul. 14, 2004
(86) PCT No.: PCT/JP04/10051

§ 371 Date: Jan. 11, 2006

(30) Foreign Application Priority Data
Jul. 15, 2003 (JP) 2003-274671

(51) Int. Cl. A01N 3/02

(52) U.S. Cl. 504/114

(57) ABSTRACT

A process for producing an artificial flower from a natural plant uses a finishing agent consisting of a solvent containing: (a) aC₁-C₃ lower alcohol and (b) at least one type of polyhydric alcohol and/or a glycol ether at a weight ratio of 1 to 99:99 to 1. A dye, an antioxidant, an ultraviolet ray protective agent, a fragrant material, etc. may be added to the finishing agent. It is preferred to effect simultaneous use of a polyhydric alcohol and a glycol ether as the component (b). Although an artificial flower of high quality can be easily produced only through the process of directly immersing a plant in the finishing agent followed by drying, products of enriched variety can be obtained through the process by impregnating a flower, etc. with a volatile organic solvent so as to effect dehydration and decolorization, by subsequently treating with a polyoxyethylene derivative solution and thereafter by applying the finishing agent having a dye appropriately added thereto.

### 1. TECHNICAL FIELD

The present invention relates to a process for producing artificial flowers with use of natural plants, and a finishing agent used in the process.

### 2. BACKGROUND ART

As for a process for producing artificial flowers with use of natural plants, Pat. Reference 1 proposes a method wherein water in fresh flowers is substituted with a water-soluble organic solvent having a smaller specific gravity than water to dehydrate the flowers, and then, cells in the flowers are saturated with a mixture of a non-hydrophilic and substantially non-volatile material, which can pass through the cell membranes and is solid or liquid in a normal temperature, and a small amount of polyols. Thereafter, many propositions such as by Pat. References 2-8 were made as for such kinds of method. Coloring with further adding a dye to the polyols was also effectuated. However, by these methods, there have been a problem about long stability of the products, and defects about color-fading and getting-out-of-shape of the flowers, etc. Furthermore, there has been a limit for the plants to which these methods can be applied. Generally, by these methods, artificial flowers of commercial value can be produced from such plants that can easily be prepared to dry flowers, while those methods have never been able to be applied to Western orchid, Lily, and Cherry blossoms of thin petals, etc.

Furthermore, a skill has been required to obtain products of commercial value, and therefore, an amateur has never been able to easily produce artificial flowers of high quality.

Pat. Reference 1: JP-B-S49-18730

Pat. Reference 2: JP-A-S54-10033

Pat. Reference 3: JP-A-H04-505766

Pat. Reference 4: JP-A-2000-191402

Pat. Reference 5: JP-A-2001-2501

Pat. Reference 6: JP-A-2001-131001

Pat. Reference 7: JP-A-2001-233702

Pat. Reference 8: JP-A-2003-26501

### DISCLOSURE OF THE INVENTION

### Problem to be Solved by the Invention

The problem of this invention is to provide a process for producing artificial flowers, a process with which such defects can be solved and anyone can easily produce from a variety of natural plants constantly artificial flowers which keep vivid colors durably and freshly; and a finishing agent for using in the method.

### MEANS FOR SOLVING THE PROBLEM

This invention relates to a process for producing artificial flowers with using natural plants. The process can solve the problems by using a finishing agent, which consists of a solvent containing:

a) a lower alcohol of C1-C3, and

b) at least one of polyhydric alcohols and/or glycol ethers in a weight ratio of 1-99:99-1.

As the polyhydric alcohols, for example, ethylene glycol, propylene glycol, diethylene glycol, dipropylene glycol, butyldiglycol, glycerin, thiodiethylene glycol, monoethyl glycol, polyethylene glycol, polypropylene glycol, poly(oxyethylene.oxypropylene)glycol, ethyldiethylene glycol, polyoxypropylenetriol, and poly(oxyethylene.oxypropylene)triol, etc, are preferably used. As the glycol ethers, for example, diethylene glycol monomethylether, triethyleneglycol monomethylether, diethyleneglycol monoethylether, triethyleneglycol monoethylether, diethyleneglycol monobutylether, triethyleneglycol monobutylether, polyethyleneglycol monoalkylether, dipropyleneglycol monomethylether, polypropyleneglycol monoalkylether and poly(oxyethylene.oxypropylene)glycol monoalkylether, etc, are preferably used.

This finishing agent can be applied directly to plants, and artificial flowers of natural appearance not inferior to natural ones can be constantly produced according to a simple method wherein the plants are directly dipped in this finishing agent, left for a certain time, then taken out of the finishing agent and dried. As an alternative, this finishing agent can be effectively applied to the artificial flowers prepared with conventional methods, as a post-treatment agent. This application of the finishing agent can be made not only just after, but also a certain time later after the preparation of the artificial flowers. By either method, freshness of the artificial flowers can be increased and the color-fading thereof be prevented.

Dyes can be optionally added and used in this finishing agent. A finishing agent containing a dye can be applied to a part of an already colored artificial flower to prepare the flower to be a natural and shaded color.

Ultraviolet absorbents ant flavors can further be added in this finishing agent. The used amounts of ultraviolet absorbents, flavors and dyes are not limited. Each of the amounts may be not more than a few % against the solvent, for example, such a level as 0.001-2%.

The a) component in the finishing agent acts as a solvent for ultraviolet absorbents (including UV cutting agent) or flavors and acts to make them infiltrate and adsorb to the artificial flowers. After the a) component volatilizes, the b) component partly remains in the artificial flowers to provide moisture to the flowers. Here, on using dyes in the finishing agent, the b) component also acts to enhance the dyeing effects of the dyes. As the a) component, methyl alcohol and ethyl alcohol are preferably used. The weight ratio of the a) component and the b) component compounded may be 1-99:99-1, preferably 5-95:95-5 and more particularly 10-90: 90-10.

As the ultraviolet absorbents and the flavors, those which are compatible with solvents of the finishing agents can be used. As the ultraviolet absorbents, for example, benzophenone derivatives and benzotriazole derivatives are mainly used. As the flavors, those having same kinds of fragrance to fresh flowers are preferably used.

In the invention, oxidation inhibitors may be added in the finishing agents to prevent color-fading by oxidation of the plants. As the oxidation inhibitors, for example, 2,6-di-t-butyl-p-cresol, 4,4′-butyryden-bis(6-t-butyl-m-cresol)-p-t-butylcresol, β-butylamine, tetrakis[methylene(3,5-)di-t-butyl-4-hydroxyhydrocinnamate]methane, etc, may be used. The amounts thereof to be used may be not more than a few % against the solvents, such as a level of 0.001-2%.

The representative method for producing artificial flowers according to this invention is the one that the finishing agent of this invention is used in one solution for a production of artificial flowers and wherein natural plants are dipped directly in the finishing agents, and left therein for at least 8 hours, preferably at least 12 hours, then are taken out from the finishing agent and dried.

According to this invention, by using polyhydric alcohol(s) and glycol ether(s) in combination as the b) component, it becomes possible to prepare artificial flowers of natural appearance even from a Lily, Western Orchid, Cherry blossoms, etc., whose fresh plants have never been able to be prepared to artificial flowers with keeping their natural states, until this invention. This is because glycol ethers effectively act to the spongiform tissues of the plants as a shape-maintaining agent to stiffen the cells thereof and make it possible to hold their stable shapes.

As for large plants such as a sunflower, etc., which are difficult to remove the alcohols saturated inside thereof, artificial flowers thereof of very good appearances without shrinkage of their petals can be produced by the following method. Firstly the plants are saturated with the finishing agents of this invention. Then they are dipped in a hydrophobic volatile solvent (such as normal hexanes) for a short time to remove the alcohols saturated inside the plants, and then, are dried. By this method, the saturated plants can be dried uniformly.

According to this invention, by using isopropyl alcohol in at least a part of the a) component, it makes possible to control discoloring of the plants, and therefore to produce artificial flowers which keep the original colors thereof without using a dye.

The finishing agent of this invention is also effective for a post-treatment of the artificial plants produced by conventional methods. For example, the finishing agent of this invention can be applied to at least a part of the surfaces of the fresh flowers which were treated with the polyoxyethylene derivative according to the method wherein water in plants is substituted with a water-soluble and volatile organic solvent having a specific gravity smaller than those of water (A liquid), and then, the organic solvent is substituted with a polyoxyethylene derivative solution (B liquid) to produce artificial flowers which can be preserved for a long time.

As the A liquid, methyl alcohol, ethyl alcohol, acetone and the like can be used, and methyl alcohol may preferably be used. As the B liquid, such a solution that contains polyoxyethylene derivative(s) may be used, and as the solvents thereof, those which belong to the same class to the A liquid, such as methyl alcohol, etc., may preferably be used.

By substituting water in plants with the A liquid and drying the plants, the plants are prepared to artificial flowers which would never rot. Here, the color of the plants shall be de-colored and therefore, dyes are properly added to the A or B liquid to be used. Then, the B liquid is saturated into the fresh flowers to provide moisture to the flower products like fresh ones.

Here, according to this invention, the finishing agent is then applied to at least a part of the surfaces of the products to enhance stability of the shape of the products and prevent out-of-shaping and color-fading during the saturation while enhancing light-resistance, to obtain products of high quality without color-fading. Here, a fragrance like fresh flowers shall be provided to the products. By adding appropriate dyes to the finishing agent, it also makes possible to control the color of the flowers to their natural nuances.

### EFFECTS OF INVENTION

According to this invention, a finishing agent can be provided, the agent which can be used while taking original strength or flexibility of the treated plants into consideration. Therefore, it becomes possible that any plant can be preserved for a long time with keeping their natural states. Aquatic plants, such as East Indian Lotus, etc., have never been able to be preserved as artificial flowers by conventional methods in which only an aspect of keeping moisture is taken into consideration. However, according to this invention, such plants can also be preserved and displayed as flexible artificial flowers of natural appearances (that is, specimens prepared from real flowers).

According to this invention, anyone can easily produce artificial flowers of high quality and commercial value because of the following reasons: Washing of the plants taken out from the finishing agents is never required. Therefore, color dyed with the finishing agents can faithfully be reappeared. Color-patches and color-failings usually occurred by such a washing are never occurred. Particularly, “Someiyoshino” (a cherry blossom) having extremely thin petals from which the color and the finishing agent are to be easily lost, has been able to be prepared to an artificial flower by this invention firstly now.

### DESCRIPTION OF THE PREFERRED EMBODIMENTS

Examples of the present invention will be illustrated, but the present invention is not limited by the examples. The glycol ether used in Examples 1-13 is a mixture of polyethyleneglycol monomethylether and di- or tri-ethyleneglycol monoethylether.

### EXAMPLES

### Example 1

One-Solution Treatment:

Yellow Rose was dipped for 12 hours in the solution containing:

| | |
|---|---|
| Ethyl alcohol | 500 cc |
| Isopropyl alcohol | 100 cc |
| Glycol ether | 100 cc |
| Ethyleneglycol | 150 cc |

Dye (Yellow),
then taken out from the solution and naturally dried. The Rose was kept in the natural state with the natural appearance for one year.

### Example 2

One-Solution Treatment:

Yellow Rose was dipped in the solution containing:

| | |
|---|---|
| Ethyl alcohol | 500 cc |
| Glycol ether | 100 cc |
| Ethyleneglycol | 100 cc |
| Glycerine | 50 cc |

Dye (Blue),
and then heated to 45° C. in hot water, and kept at 45° C. for 3 hours. Then the Rose was taken out of the solution and heated in a microwave oven to be compulsorily dried.

### Example 3

One-Solution Treatment:

Cattleya was dipped for 24 hours in the solution containing:

| | |
|---|---|
| Ethyl alcohol | 500 cc |
| Isopropyl alcohol | 100 cc |
| Glycol ether | 150 cc |
| Ethyleneglycol | 150 cc |

Dye (Purple),
then taken out from the solution and naturally dried. The Cattleya was dyed purple color with maintaining their natural appearance and substantially was not changed even after one year.

### Example 4

Two-Solution Treatment:

White Rose was dipped for 12 hours in ethyl alcohol, then, dipped for 12 hours in the solution containing:

| | |
|---|---|
| Ethyl alcohol | 300 cc |
| Ethyleneglycol | 100 cc |
| Glycol ether | 100 cc |

Dye (Red),
then taken out from the solution and naturally dried. The Roses were dyed red color with maintaining their natural appearance and the feature was kept even after one year.

### Example 5

Two-Solution Treatment:

Red Rose was dipped for 12 hours in the solution containing

| | |
|---|---|
| Ethyl alcohol | 500 cc |
| Xylene | 100 cc, |

and then 5 cc of 20% sodium hypochlorite was added at 5 minutes interval in the solution until the total amount was 50 cc, and further the Rose was left in the solution. Then, the Rose was taken out from the solution and dipped for 12 hours in the solution containing:

| | |
|---|---|
| Ethyl alcohol | 500 cc |
| Ethyleneglycol | 100 cc |
| Glycol ether | 100 cc |
| Glycerine | 5 cc |
| Polyethyleneglycol | 10 cc |

and then naturally dried. The red Rose was bleached to be prepared to pure white Rose. The Rose kept their natural states having natural appearance as white Rose.

### Example 6

One-Solution Treatment:

Flowers of Prunus Xyedonesis (“Someiyoshino”, cherry blossom) were dipped for 4 hours in the solution containing:

| | | |
|---|---|---|
| Ethyl alcohol | 1000 | cc |
| Isopropyl alcohol | 150 | cc |
| Ethyleneglycol | 50 | cc |
| Glycol ether | 80 | cc |
| Oxidation Inhibitor | 2 | cc |

Dye (cherry pink),
then taken out from the solution and heated in a microwave oven to be compulsorily dried. The flowers were dyed cherry pink with keeping their natural appearance. Their shape and color-nuance were not changed and the flowers were kept in the fresh state even after one year.

### Example 7

Two-Solution Treatment:

Casablanca (lily) was dipped for 12 hours in the solution containing:

| | |
|---|---|
| Ethyl alcohol | 500 cc |
| Isopropyl alcohol | 500 cc, |

then dipped for 24 hours in the solution containing:

| | |
|---|---|
| Ethyl alcohol | 500 cc |
| Ethyleneglycol | 200 cc |
| Glycol ether | 100 cc |
| Oxidation Inhibitor | 10 cc |

and then dried. The natural appearance of Casablanca was not changed and was stably maintained even after one year.

### Example 8

One-Solution Treatment:

Flowers of Hydrangea were dipped for 12 hours in the solution containing:

| | | |
|---|---|---|
| Isopropyl alcohol | 600 | cc |
| Ethyleneglycol | 80 | cc |
| Glycol ether | 120 | cc |
| Oxidation Inhibitor | 3 | cc |
| Glycerine | 10 | cc, |

then taken out from the solution and naturally dried.

By using isopropyl alcohol in which the wild color of plants is relatively stable in order to keep the original color of the Hydrangea, the original light color of the Hydrangea was able to be kept. The Hydrangeas were kept their natural states of natural appearance even after one year.

### Example 9

One-Solution Treatment:

Dendrobium Phalaenopsis (Orchid) was dipped in the solution containing:

| | |
|---|---|
| Ethyl alcohol | 1000 cc |
| Ethyleneglycol | 300 cc |
| Glycol ether | 100 cc |
| Polyethyleneglycol | 10 cc. |

They were heated in a microwave oven for 5 minutes together with the container and left under natural condition. Then the Dendrobium Phalaenopsis was kept being dipped for 12 hours. The Dendrobium Phalaenopsis taken out from the solution was decolored. By being dried compulsorily in an electric range weakly, the Dendrobium Phalaenopsis turn white because of the decoloring, with keeping the natural appearance and being white Dendrobium Phalaenopsis with no change for a year.

### Example 10

One-Solution Treatment:

Flowers of White Chrysanthemum were dipped for 24 hours in the solution containing:

| | |
|---|---|
| Ethyl alcohol | 500 cc |
| Ethyleneglycol | 150 cc |
| Glycol ether | 120 cc |
| Glycerine | 20 cc |

Dye (Orange)
, then taken out from the solution. Then, the flowers were placed for 5 minutes in the container in which 500 cc of normal hexane was poured to remove the alcohols and the flowers were dried. According to this method, artificial flowers were also able to be produced from such plants that alcohols had been difficult to be evaporated from inside of them, and therefore that had never been uniformly dried and had been shrunk. This is effective mainly for plants in a class of Chrysanthemum. Large plants such as a Sunflower, etc., can also be uniformly dried and therefore can keep their beautiful appearances with little shrinkage of their petals. The White Chrysanthemum was dyed to orange with keeping the natural appearance and kept the natural state with no change for a year.

### Example 11

One-Solution Treatment:

Asparapera after sufficiently water rising was dipped for 12 hours in the solution containing:

| | |
|---|---|
| Ethyl alcohol | 1000 cc |
| Isopropyl alcohol | 100 cc |
| Glycol ether | 200 cc |
| Ethyleneglycol | 100 cc |
| Glycerine | 20 cc |
| Polyethyleneglycol | 10 cc |

Dye (Green)
, then taken out from the solution and naturally dried. Preserved green leaves of the Asparapera which remain the natural appearance was obtained and they kept such appearance for a year.

### Example 12

One-Solution Treatment:

Leather Fern after sufficiently water rising was dipped for 24 hours in the solution containing:

| | |
|---|---|
| Ethyl alcohol | 1000 cc |
| Isopropyl alcohol | 200 cc |
| Glycol ether | 250 cc |
| Ethyleneglycol | 150 cc |
| Glycerine | 10 cc |

Dye (pale pink)
, then taken out from the solution. Then, the solution in the plants was drained for about 5 minutes. After that, the plants were placed under −500 mmHg with using a vacuum pump in a decompression device, then heated and dried. After 1 hour of decompressed drying, the preserved leaves of the Leather Fern which were taken out from the device, were pale pink with keeping their natural appearance with no change for a year.

### Example 13

One-Solution Treatment:

Flowers of East Indian Lotus were placed for 48 hours in the solution containing:

| | |
|---|---|
| Ethyl alcohol | 1500 cc |
| Isopropyl alcohol | 500 cc |
| Glycol ether | 500 cc |
| Ethyleneglycol | 200 cc |
| Polyethyleneglycol | 30 cc |

, taken out from the solution and naturally dried. The East Indian Lotus was prepared to such appearance that the color was completely lost to be white. Then, a paint containing pigments as main components was applied to the flowers to prepare color-nuances of the original states of the flowers. The Lotus was prepared to preserved flowers whose colors were recovered to those of fresh flowers. The beautiful appearance was kept without a change for a year.

### Example 14

One-Solution Treatment:

Flower parts of Rose were dipped for 24 hours in the solution containing:

| | |
|---|---|
| Methyl alcohol | 750 cc |
| Dipropyleneglycol | 250 cc |

Dye (Red)
, then taken out from the solution and were dried. The Rose was dyed red and kept to be beautiful with keeping the natural appearance with substantially no change for at least one year.

### Example 15

One-Solution Treatment:

Flower pars of Rose were dipped for 24 hours in the solution containing:

| | |
|---|---|
| Methyl alcohol | 750 cc |
| Propyleneglycol | 250 cc |

Dye (Blue)
, then taken out and naturally dried. The Rose was dyed blue and kept to be beautiful with keeping the natural appearance with substantially no change for at least one year.

### Example 16

One-Solution Treatment:

Flower parts of Rose were dipped for 24 hours in the solution containing:

| | |
|---|---|
| Methyl alcohol | 750 cc |
| Polyoxyalkylene ether | 250 cc |
| (ADEKA CARPOL MBF-100 | |
| of ASAHIDENNKA KOUGYOU K.K.) | |

Dye (Yellow)
, then taken out and naturally dried. The Rose was dyed yellow and kept to be beautiful with keeping the natural appearance with substantially no change for at least one year.

### Example 17

One-Solution Treatment:

Flower parts of Carnation were dipped for 48 hours in the solution containing:

| | |
|---|---|
| Methyl alcohol | 750 cc |
| Polyoxyalkylene ether | 100 cc |
| (ADEKA CARPOL MBF-100 of | |
| ASAHIDENNKA KOUGYOU K.K.) | |
| Propyleneglycol | 150 cc |

Dye (Purple)
, then taken out and naturally dried. The Carnation was dyed purple and kept to be beautiful with keeping the natural appearance with substantially no change for at least one year.

### Example 18

One-Solution Treatment:

Flower parts of Casa Blanca were dipped for 40 hours in the solution containing:

| | |
|---|---|
| Methyl alcohol | 1500 cc |
| Dipropyleneglycol | 300 cc |
| Propyleneglycol | 300 cc |

Dye (Purple)
, then taken out and naturally dried. The Casa Blanca was dyed pure white and for at kept to be beautiful with keeping the natural appearance with substantially no change for at least one year.

### Example 19

One-Solution Treatment:

Leaves of Ivy were dipped for 36 hours in the solution containing:

| | |
|---|---|
| Methyl alcohol | 750 cc |
| Polyoxyalkylene ether | 100 cc |
| (ADEKA CARPOL MBF-100 of ASAHIDENNKA KOUGYOU | |
| K.K.) | |
| Dipropyleneglycol | 150 cc |

Dye (Bright Green)
, then taken out and naturally dried. The leaves of Ivy were dyed bright green and kept to be beautiful with keeping the natural appearance with substantially no change for at least one year.

### Example 20

One-Solution Treatment:

Leaves of Leather Fern from were dipped for 24 hours in the solution containing:

| | |
|---|---|
| Ethyl alcohol | 650 cc |
| Isopropyl alcohol | 100 cc |
| Propyleneglycol | 300 cc |

Dye (Green)
, then taken out and naturally dried. The leaves of the Leather Fern were dyed green and kept to be beautiful with keeping the natural appearance with substantially no change for at least one year.

### Example 21

One-Solution Treatment:

Flower parts of Moth Orchid were dipped for 24 hours in the solution containing:

| | |
|---|---|
| Ethyl alcohol | 1400 cc |
| Isopropyl alcohol | 100 cc |
| Dipropyleneglycol | 800 cc |

Dye (Salmon Pink)
, then taken out and naturally dried. The flowers of the Moth Orchid were dyed salmon pink and kept to be beautiful with keeping their natural appearance with substantially no change for at least one year.

### Example 22

One-Solution Treatment:

Flower parts of East Indian Lotus were dipped for 48 hours in the solution containing:

| | |
|---|---|
| Ethylalcohol | 1300 cc |
| Isopropylalcohol | 200 cc |
| Polyoxyalkylene ether | 500 cc |
| (ADEKA CARPOL MBF-100 of ASAHIDENNKA | |
| KOUGYOU K.K.) | |

Dye (pale pink)
, then taken out and naturally dried. The flowers of the East Indian Lotus were dyed pale pink and kept to be beautiful with keeping the natural appearance with substantially no change for at least one year.

### Example 23

One-Solution Treatment:

Flower parts of Rose were dipped for 24 hours in the solution containing:

| | |
|---|---|
| Ethyl alcohol | 650 cc |
| Isopropyl alcohol | 100 cc |
| Polyoxyalkylene ether | 100 cc |
| (ADEKA CARPOL MBF-100 of ASAHIDENNKA | |
| KOUGYOU K.K.) | |
| Propyleneglycol | 150 cc |

Dye (Red-Purple)
, then taken out and naturally dried. The flowers of the Rose was dyed red-purple and kept to be beautiful with keeping the natural appearance with substantially no change for at least one year.

### Example 24

One-Solution Treatment:

Flower parts of Balloon Flower were dipped for 24 hours in the solution containing:

| | |
|---|---|
| Ethyl alcohol | 550 cc |
| Isopropyl alcohol | 150 cc |
| Diprolyleneglycol | 150 cc |
| Propyleneglycol | 100 cc |

Dye (Blue)
, then taken out and naturally dried. The flowers of the Balloon Flower were dyed blue and kept to be beautiful with keeping the natural appearance with substantially no change for at least one year.

### Example 25

One-Solution Treatment:

Flower parts of Cosmos were dipped for 12 hours in the solution containing:

| | |
|---|---|
| Ethyl alcohol | 650 cc |
| Isopropyl alcohol | 100 cc |
| Polyoxyalkylene ether | 100 cc |
| (ADEKA CARPOL MBF-100 of ASAHIDENNKA | |
| KOUGYOU K.K.) | |
| Dipropyleneglycol | 150 cc |

Dye (Brown)
, then taken out and naturally dried. The flowers of the Cosmos were dyed brown and kept to be beautiful with keeping the natural appearance with substantially no change for at least one year.

### Example 26

One-Solution Treatment:

Flower parts of Rose were dipped for 24 hours in the solution containing:

| | |
|---|---|
| Methyl alcohol | 750 cc |
| Polyoxyalkylene ether | 250 cc |
| (ADEKA CARPOL MBF-100 of ASAHIDENNKA | |
| KOUGYOU K.K.) | |

Dye (Bright Yellow)
, then taken out and compulsorily dried in a microwave oven. The flowers of the Rose were dyed bright yellow and kept to be beautiful with keeping the natural appearance with substantially no change for at least one year.

### Example 27

One-Solution Treatment:

Flower parts of Carnation were dipped for 48 hours in the solution containing:

| | |
|---|---|
| Methyl alcohol | 750 cc |
| Polyoxyalkylene ether | 100 cc |
| (ADEKA CARPOL MBF-100 of ASAHIDENNKA | |
| KOUGYOU K.K.) | |
| Propyleneglycol | 150 cc |

Dye (Yellow-Green)
, then taken out and naturally dried. The flowers of the Carnation were dyed yellow-green and kept to be beautiful with keeping the natural appearances with substantially no change for at least one year.

### Example 28

One-Solution Treatment:

Flower parts of Hydrangea were dipped for 20 hours in the solution containing:

| | |
|---|---|
| Methyl alcohol | 750 cc |
| Dipropyleneglycol | 300 cc |
| Propyleneglycol | 300 cc |

Dye (Sky Blue)
, then taken out and naturally dried. The flowers of the Hydrangea were dyed sky-blue and kept to be beautiful with keeping the natural appearance with substantially no change for at least one year.

### Example 29

One-Solution Treatment:

Leaves of Ivy were dipped for 36 hours in the solution containing:

| | | |
|---|---|---|
| Methyl alcohol | 745 | cc |
| Polyoxyalkylene ether | 100 | cc |
| (ADEKA CARPOL MBF-100 of | | |
| ASAHIDENNKA KOUGYOU K.K.) | | |
| Dipropyleneglycol | 150 | cc |
| Methylacetate | 3 | cc |
| Butylacetate | 2 | cc |

Dye (Young-Green)
, then taken out and naturally dried. The leaves of the Ive were dyed young-green and kept to be beautiful with keeping the natural appearances with substantially no change for at least one year.

### Example 30

One-Solution Treatment:

Leaves of Leather Fern were dipped for 24 hours in the solution containing:

| | | |
|---|---|---|
| Ethylalcohol | 650 | cc |
| Isopropylalcohol | 90 | cc |
| Dipropyleneglycol | 300 | cc |
| Butylacetate | 5 | cc |
| Ethylacetate | 5 | cc |

Dye (Green)
, then taken out and naturally dried. The leaves of the Leather Fern were dyed green and kept to be beautiful with keeping the natural appearance with substantially no change for at least one year.

### Example 31

Preparation Of The Finishing Agent I:

A benzotriazole based-UV absorbent and a flavor in a class of Rose were added to the solution containing 37% of methylalcohol, 43% of butyldiglycol, and 21% of ethyleneglycol to prepare a finishing agent.

Method For Producing Artificial Flowers:

After sufficiently water rising of Rose, the flower parts each containing 1 cm of the stalk below the flower were cut out. The flower parts were dipped in methyl alcohol (A solution) and were left for 2 hours to be dehydrated and decolored. Then, they were dipped in the 67% methylalcohol solution of polyoxyalkylene alkylether (B solution) to saturate the B solution into the flowers. The flowers were taken out from the solution, and the polyoxyalkylene alkylether on the surfaces of the flowers were wiped away with methylalcohol. Then, 2 colors (dark and light) of the finishing agents which had been prepared by respectively further adding a dye to the finishing agent I were adhered to the surfaces of the flowers.

The obtained products were artificial flowers like natural Rose of good fragrance, the artificial flowers which have bright color-nuance with changes in their tone. Each of the petals had moisture like fresh flowers.

These products kept their superior qualities without out-of-shaping and decoloring even under humidity. They kept fresh appearances like natural Rose after leaving them for a long time.

1-17. (canceled)

18: A finishing agent for producing artificial flowers from natural plants with keeping the natural states of the plants, the finishing agent which consists of a solvent containing:
a) a lower alcohol of C1-C3; and
b) at least one of glycol ethers in a weight ratio of 1-99:99-1.

19: The finishing agent according to claim 18, wherein the glycolether is selected from the group consisting of diethyleneglycol monomethylether, triethyleneglycol monomethylether, diethyleneglycol monoethylether, triethyleneglycol monoethylether, diethyleneglycol monobutylether, triethyleneglycol monobutylether, polyethyleneglycol monoalkylether, dipropyleneglycol monomethylether, polypropyleneglycol monoalkylether and poly(oxyethylene-oxypropylene)glycol monoalkylether.

20: The finishing agent according to claim 18, wherein a polyhydric alcohol and a glycolether are used in combination as the b) component.

21: The finishing agent according to claim 18, wherein a dye is added and mixed.

22: The finishing agent according to claim 18, wherein an oxidation inhibitor is contained.

23: The finishing agent according to claim 20, wherein the polyhydric alcohol is selected from the group consisting of ethylene glycol, propylene glycol, diethylene glycol, dipropylene glycol, butyldiglycol, glycerin, thiodiethylene glycol, monoethyl glycol, polyethylene glycol, polypropylene glycol, poly(oxyethylene-oxypropylene)glycol, ethyldiethylene glycol, polyoxypropylenetriol, and poly(oxyethylene-oxypropylene)triol.

24: A process for producing artificial flowers, wherein flowers or leaves of plants are dipped directly in a finishing agent consisting of a solvent containing a lower alcohol of C1-C3 and at least one of glycol ethers in a weight ratio of 1-99: 99-1, and then they are dried, to be prepared to artificial flowers or leaves which can be preserved for a long time with keeping their natural states.

25: A process for producing artificial flowers, wherein water in plants is substituted with a water-soluble and volatile organic solvent having a specific gravity smaller than water (A solution) and then, the organic solvent is substituted with a polyoxyethylene derivative solution (B solution), to prepare the fresh flowers of the plants to artificial flowers which can be preserved for a long time; and a finishing agent consisting of a solvent containing a lower alcohol of C1-C3 and at least one of glycol ethers in a weight ratio of 1-99: 99-1 is applied to at least a part of the surfaces of the fresh flowers treated with the polyoxyethylene derivative.
